(19) United States
(12) Patent Application Publication
(10) Pub. No.: US 2017/0338001 A1
(43) Pub. Date: Nov. 23, 2017

(54) RESIN COMPOSITION AND INSULATED ELECTRICAL WIRE USING THE SAME

(71) Applicant: YAZAKI CORPORATION, Tokyo (JP)

(72) Inventor: Daisuke SUZUKI, Shizuoka (JP)

(73) Assignee: YAZAKI CORPORATION, Tokyo (JP)

(21) Appl. No.: 15/597,397

(22) Filed: May 17, 2017

(30) Foreign Application Priority Data
May 20, 2016 (JP) 2016-101068

(51) Int. Cl. H01B 3/44; C08K 5/12; C09D 7/12; C09D 127/06

(52) U.S. Cl. CPC H01B 3/443; C09D 127/06; C08K 5/12; C09D 7/1233

(57) ABSTRACT

A resin composition contains a vinyl chloride resin and a dinonyl phthalate. When a serape abrasion test specified in JASO D618 is conducted on an insulated. electrical wire including a conductor having a cross-sectional area of 0.3 mm² covered with the resin composition in a thickness of 0.30 mm, the number of reciprocations is 100 or more. When the insulated electrical wire is wound around a mandrel having the same diameter as that of the insulated electrical wire in an environment of −65° C., the conductor is not exposed. When the insulated electrical wire having been heated at 85° C. for 3000 hours is wound around a mandrel having a diameter 1.5 times as large as that of the insulated electrical wire in an environment of 23 ±5° C., the conductor is not exposed.

### CROSS REFERENCE TO RELATED APPLICATIONS

This application claims the priority of Japanese Patent Application No. 2016-101068, filed on May 20, 2016, the entire content of which are incorporated herein by reference.

### BACKGROUND

### Technical Field

The present invention relates to a resin composition and an insulated electrical wire using the resin composition. Specifically, the present invention relates to a resin. composition for enhancing abrasion resistance, low-temperature flexibility, and heat resistance, as well as an insulated electrical wire using the resin composition.

### Related Art

Coated electrical wires such as a wire harness used in an automobile are left in a high-temperature state for a long period in an engine room or the like, so that the mechanical properties of the material may deteriorate. To prevent this deterioration, coated electrical wires are demanded to have a heat resistance.

Moreover, coated electrical wires such as a wire harness used in an automobile are demanded to have a thin cover layer configured to cover conductors of the electrical wires because of downsizing of electronic devices, for example. On the other hand, such a cover layer has to withstand vibrations of an automobile, so that a higher abrasion resistance is demanded.

Heretofore, as a resin composition having such high heat resistance and . abrasion resistance, there has been disclosed a thin, abrasion-resistant vinyl chloride resin composition for covering an electrical wire, the composition containing polyvinyl chloride blended with plasticizers (see, JP 2013-40268 A). It is also disclosed that, in the vinyl chloride resin composition, polyvinyl chloride is blended with a trimellitate plasticizer and a phthalate plasticizer. It is further disclosed that the trimellitate plasticizer has a linear alkyl group with 8 or more carbon atoms, and that the phthalate plasticizer has a linear alkyl group with 10 or more carbon atoms.

### SUMMARY

However, the vinyl chloride resin composition of JP 2013-40268 A may not necessarily have a sufficient flexibility in such a low temperature environment as, for example, −65° C.

The present invention has been made in view of such problems of the conventional techniques. An object of the present invention is to provide: a resin composition having enhanced heat resistance, abrasion resistance, and low-temperature flexibility; and an insulated electrical wire using the resin composition.

A resin composition according to a first aspect of the present invention contains a vinyl chloride resin and a dinonyl phthalate. When a scrape abrasion test specified in JASO D618 is conducted on an insulated electrical wire including a conductor having a cross-sectional area of 0.3 mm² covered with the resin composition in a thickness of 0.30 mm, the number of reciprocations is 100 or more. When the insulated electrical wire is wound around a mandrel having the same diameter as that of the insulated electrical wire in an environment of −65° C., the conductor is not exposed. When the insulated electrical wire having been heated at 85° C. for 3000 hours is wound around a mandrel having a diameter 1.5 times as large as that of the insulated electrical wire in an environment of 23 ±5° C., the conductor is not exposed.

A content of the dinonyl phthalate may be 35 to 60 parts by mass relative to 100 parts by mass of the vinyl chloride resin.

The vinyl chloride resin may have a degree of polymerization of 1000 to 2500.

An insulated electrical wire according to a second aspect of the present invention includes a cover layer made of the resin composition according to the first aspect and a conductor covered with the cover layer.

The resin composition according to the aspects of the present invention. provides a resin composition having enhanced heat resistance, abrasion resistance, and low-temperature flexibility; and an insulated electrical wire using the resin composition.

### BRIEF DESCRIPTION OF DRAWINGS

FIG. 1 is a cross section showing a structure of an insulated wire according to an embodiment of the present invention.

### DETAILED DESCRIPTION

Using the drawings, a detailed description is given of a resin composition and an insulated wire according to an embodiment of the present invention. Note that the dimensional ratios in the drawings are exaggerated for illustrative convenience, and may be different from actual ratios.

[Resin Composition]

The resin composition according to the present embodiment mainly contains a vinyl chloride resin. The vinyl chloride resin is a material having a high heat resistance without cross-linking treatment, and further being excellent in electrical insulation, inexpensive, and easy to process. Nevertheless, with the vinyl chloride resin alone, the low-temperature flexibility deteriorates. For this reason, adding a plasticizer has been studied to improve the low-temperature flexibility.

As such plasticizers for improving the low-temperature flexibility, trimellitate plasticizers, phthalate plasticizers, and the like have been known. However, even when these plasticizers are used, a sufficient flexibility is not necessarily obtained at such a low temperature as −65° C.

Hence, the resin composition of the present embodiment uses dinonyl phthalate as a plasticizer. Dinonyl phthalate is a phthalate plasticizer. The use of this plasticizer makes it possible to obtain a resin composition excellent in abrasion resistance, low-temperature flexibility, and heat resistance.

Examples of the vinyl chloride resin used in the resin composition of the present embodiment include polyvinyl chloride, chlorinated polyvinyl chloride, polyvinylidene chloride, chlorinated polyethylene, vinyl chloride-vinyl acetate copolymers, vinyl chloride-ethylene copolymers, vinyl chloride-propylene copolymers, vinyl chloride-styrene copolymers, vinyl chloride-isobutylene copolymers, vinyl chloride-vinylidene chloride copolymers, vinyl chloride-styrene-maleic anhydride copolymers, vinyl chloride-styrene-acrylonitrile copolymers, vinyl chloride-butadiene copolymers, vinyl chloride-isoprene copolymers, vinyl chloride-chlorinated propylene copolymers, vinyl chloride-vinylidene chloride -vinyl acetate copolymers, vinyl chloride-maleic acid ester copolymers, vinyl chloride-methacrylic acid ester copolymers, vinyl chloride-acrylonitrile copolymers, copolymers of vinyl chloride and various vinyl ethers, and the like. One of these vinyl chloride resins may be used alone, or two or more thereof may be used in combination. Note that the polymerization method of the vinyl chloride resin may be bulk polymerization, solution polymerization, suspension polymerization, emulsion polymerization, and the like without particular limitation.

The average degree of polymerization (weight-average degree of polymerization) of the vinyl chloride resin is not particularly limited, hut is preferably 500 to 5000. The vinyl chloride resin having an average degree of polymerization of 500 or more can suppress a deterioration in the abrasion resistance of the resin composition to be obtained. Meanwhile, when the resin composition is to be extrusion-molded, the vinyl chloride resin having an average degree of polymerization of 5000 or less can suppress an increase in the melt viscosity during the extrusion-molding, and further prevent deteriorations in kneading and molding processabilities. Moreover, the vinyl chloride resin more preferably has an average degree of polymerization of 1000 to 2500. When the vinyl chloride resin has an average degree of polymerization within this range, it is possible to obtain a favorable resin composition terms of abrasion resistance and molding processability. Note that, in the resin composition of the present embodiment, one or two or more vinyl chloride resins each having a degree of polymerization within the above-described ranges may be used in combination. In addition, the average degree of polymerization can be determined according to Japanese Industrial Standard JIS K6720-2: 1999 (Plastics—Homopolymer and copolymer resins of vinyl chloride—Part 2: Preparation of test samples and determination of properties).

As the plasticizer used in the resin composition, dinonyl phthalate (DNP) (CAS Registry Number: 84-76-4) is used. Dinonyl phthalate (DNP) is classified as a phthalate plasticizer. Note that examples of plasticizers classified as the same phthalate plasticizer include didecyl phthalate (DDP), di-n-octyl phthalate (DNOP), diisononyl phthalate (DINP), and the like. Nevertheless, if plasticizers such as these plasticizers are used other than dinonyl phthalate, all the properties of abrasion resistance, low-temperature flexibility, and heat resistance cannot be satisfied at the same time. Hence, in the present embodiment, dinonyl phthalate (DNP) is used as a plasticizer.

In the resin composition, the content of dinonyl phthalate is preferably 35 to 60 parts by mass relative to 100 parts by mass of the vinyl chloride resin. The dinonyl phthalate content within this range enables a favorable low-temperature flexibility, while suppressing a deterioration in the abrasion resistance.

The resin composition of the present embodiment can be blended with various additives in addition to the above-described materials. Examples of the additives include a stabilizer, a pigment, an antioxidant, a bulking agent, a metal deactivator, an anti-aging agent, a lubricant, a filler, a stiffener, an ultraviolet absorber, a dye, a colorant, an antistat, a blowing agent, and the like.

Next, a method for producing the resin composition of the present embodiment will be described. The above-described resin composition is prepared by heating and kneading the above-described materials, and known means can be used in the method. For example, the above-described materials are kneaded using a known kneader such as a Banbury mixer, a pressure kneader, a kneading extruder, a twin screw extruder, or a roll mill, so that the resin composition can be obtained. Alternatively, the above-described materials may be dry-blended using a tumbler or he like in advance, and then kneaded using the above-described kneader. The resin composition of the present embodiment can be obtained by heating and kneading as described above.

In the present embodiment, when a scrape abrasion test specified in JASO D618 is conducted on an insulated electrical wire including a conductor having a cross-sectional area of 0.3 mm² covered with the above-described resin composition in a thickness of 0.30 mm, the number of reciprocations is 100 or more. The number of reciprocations being 100 or more in the scrape abrasion test indicates that the abrasion resistance is sufficient. Hence, the application to, for example, an electrical insulator of electrical wires such as a wire harness is possible. Note that, in the scrape abrasion test, a needle having a diameter of 0.45 ±0.01 mm can be used. Additionally, the number of reciprocations being 100 or more in the scrape abrasion test refers to a case where no electricity flows between the metal conductor and the needle having a diameter of 0.45 ±0.01 mm even when the number of reciprocations is 100 or more.

Further, in the present embodiment, when the insulated electrical wire including the conductor having a cross-sectional area of 0.3 mm² covered with the resin composition in a thickness of 0.30 mm is wound, in an environment of −65° C., around a mandrel having the same diameter 1.3 mm) as that of the insulated electrical wire, the conductor is not exposed. Since the conductor of the insulated electrical wire is not exposed under these conditions, this indicates that the low-temperature flexibility is sufficient. Hence, the application to, for example, an electrical insulator of electrical wires such as a wire harness is possible.

Moreover, in the present embodiment, when the insulated electrical wire having been heated at 85° C. for 3000 hours is wound, in an environment of 23 ±5° C., around a mandrel having a diameter (1.95 mm) 1.5 times as large as that of the insulated electrical wire, the conductor is not exposed. Note that the insulated electrical wire used in this event is an insulated electrical wire including a conductor having a cross-sectional area of 0.3 mm² covered with the resin composition in a thickness of 0.30 mm, as in the case of the above-described electrical wire. Since the conductor of the insulated electrical wire is not exposed in such a long heating test, this indicates that the heat resistance is sufficient. Hence, the application to, for example, an electrical insulator of electrical wires such as a wire harness is possible.

As described above, the resin composition of the present embodiment contains the vinyl chloride resin and dinonyl phthalate. Moreover, when a scrape abrasion test specified in JASO D618 is conducted on the insulated electrical wire including the conductor having a cross-sectional area of 0.3 mm² covered with the resin composition in a thickness of 0.30 mm, the number of reciprocations is 100 or more. Further, when the above-described insulated electrical wire is wound, in an environment of −65° C., around a mandrel having the same diameter as that of the insulated electrical wire, the conductor is not exposed. Furthermore, when the insulated electrical wire having been heated at 85° C. for 3000 hours is wound, in an environment of 23 =5° C., around the mandrel having a diameter 1.5 times as large as that of the insulated electrical wire, the conductor is not exposed. This resin composition is excellent in abrasion resistance and heat resistance in addition to low-temperature flexibility, so that the resin composition is appropriately usable as an electrical insulator of electrical wires for vehicles.

[Insulated Electrical Wire]

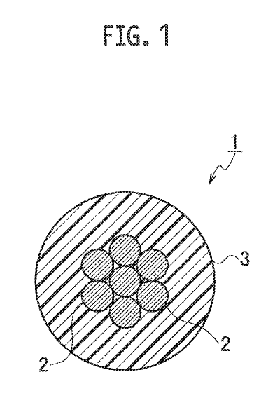

As shown in FIG. 1, an insulated electrical wire 1 according to the present embodiment includes a cover layer 3 made of the above-described resin composition, and a conductor 2 covered with the cover layer 3.

As the conductor 2, a single wire constituted of one strand may be used, or twisted wires constituted by twisting multiple strands may be used. As the twisted. wires, it is possible to use any of: concentric twisted wires including concentrically twisted strands around one or several strands serving as the center; bunch twisted wires including multiple strands twisted all together in the same direction; and rope twisted wires including multiple bunch twisted wires which are concentrically twisted.

The diameter of the conductor 2 and the diameter of each strand constituting the conductor 2 are not particularly limited, either. Further, the material of the conductor 2 is not particularly limited, either. For example, it is possible to use metals in general, conductive fibers, and conductive polymers. Particularly, known conductive metal materials such as, for example, copper, copper alloys, aluminum, and aluminum alloys can be used as the material of the conductor 2. These conductive metal materials are particularly preferable because the flexibility and conductivity are favorable. In addition, the surface of the conductor 2 may be plated, for example, tin-plated, silver-plated, or nickel-plated.

The cover layer 3 configured to cover the outer circumference of the conductor 2 is formed of a resin composition capable of ensuring the electrical insulation from the conductor 2. Specifically, the cover layer 3 is folioed of the above-described resin composition. As described above, the resin composition of the present embodiment contains the vinyl chloride resin and dinonyl phthalate; further, the number of reciprocations is 100 or more in a scrape abrasion test under predetermined conditions. Moreover, when the insulated electrical wire is wound around mandrels under predetermined conditions, the conductor is not exposed. Hence, the resin composition is excellent in abrasion resistance, low-temperature flexibility, and heat resistance, and is appropriately usable as an insulator of electrical wires.

Next, a method for producing the insulated electrical wire 1 of the present embodiment will be described. The cover layer 3 of the insulated electrical wire 1 is prepared by heating and kneading the material in the same manner as in the method for producing the above-described resin composition. Moreover, in the method for covering the conductor 2 with the cover layer 3 also, known means can be used. For example, the cover layer 3 can be formed by a general extrusion molding method. As the extruder used in the extrusion molding method, for example, a single screw extruder or a twin screw extruder is used, and it is also possible to use an extruder having a screw, a breaker plate, a cross head, a distributer, a nipple, and a dice.

Specifically, in the method for producing the insulated electrical wire 1, first, a uniform molten mixture is prepared according to a conventional method to thereby obtain the polyvinyl chloride resin composition of the present invention. Then, this resin composition is used as a resin for insulating and covering an electrical wire, and extrusion-molded together with an electrical wire (linear conductor formed of a conductive metal such as a copper wire). Thus, the resin composition solidified in a tubular form serves as an insulator, so that an insulator covering the electrical wire is formed. By such a method, the insulated electrical wire is obtained in which the electrical wire is covered with the insulator.

In addition, a wire harness according to the present embodiment includes the above-described insulated electrical wire 1. As described above, the insulated electrical wire 1 of the present embodiment has higher abrasion resistance, low-temperature flexibility, and heat resistance than conventional wires. Hence, the wire harness can be preferably used even when considerably bent within a short path and routed.

### Examples

Hereinafter, the present invention will be described in more details by way of Examples and Comparative Examples. However, the present invention is not limited to these Examples.

First, using a kneader, the following vinyl chloride resins and plasticizers in blending amounts shown in Table 1 were melted and kneaded. Thereby, resin compositions of Examples and Comparative Examples were prepared.

### (Vinyl Chloride Resin (PVC))

S1008 having a degree of polymerization of 800, manufactured by Kaneka Corporation
S1001 having a degree of polymerization of 1000, manufactured by Kaneka Corporation
S1004 having a degree of polymerization of 1400, manufactured by Kaneka Corporation
KS-2500 having a degree of polymerization of 2500, manufactured by Kaneka Corporation
KS-3000 having a degree of polymerization of 3000, manufactured by Kaneka Corporation

### (Plasticizer)

PolyOne Synplast 9P-N: dinonyl phthalate (DNP), C9 linear, manufactured by PolyOne Corporation
Vinycizer(registered trademark) 105: didecyl phthalate (DDP), C10 linear, manufactured by Kao Corporation
Vinycizer(registered trademark) 85: di-n-octyl phthalate (DNOP), C8 linear, manufactured by Kao Corporation
DINP: diisononyl phthalate (DINP), C9 branched, manufactured by J-PLUS Co., Ltd.

Next, as a metal conductor, a core wire (twisted wire) made of pure copper having a cross-sectional area of 0.3 mm² (diameter: 0.8 mm) was prepared. Then, the metal conductor was extrusion-molded using a cover extruder having a screw diameter of 40 mm for producing electrical wire under a temperature condition of approximately 180° C. Thus, test samples covered with the resin compositions of Examples and Comparative Examples were prepared. Note that, in the extrusion-molding, each cover layer was adjusted to have a thickness of 0.30 mm after the covering.

TABLE 1

| | | | | | | | Com. | Com. | Com. | Com. | Com. | Com. | Com. | Com. | Com. |
|---|---|---|---|---|---|---|---|---|---|---|---|---|---|---|---|
| | | Ex. 1 | Ex. 2 | Ex. 3 | Ex. 4 | Ex. 5 | Ex. 1 | Ex. 2 | Ex. 3 | Ex. 4 | Ex. 5 | Ex. 6 | Ex. 7 | Ex. 8 | Ex. 9 |
| PVC | degree of | — | — | — | — | — | — | — | — | — | — | — | — | — | 100 |
| | polymerization: | | | | | | | | | | | | | | |
| | 800 | | | | | | | | | | | | | | |
| | degree of | — | — | 100 | — | — | — | — | — | — | — | — | — | — | — |
| | polymerization: | | | | | | | | | | | | | | |
| | 1000 | | | | | | | | | | | | | | |
| | degree of | 100 | 100 | — | — | — | 100 | 100 | 100 | 100 | 100 | 100 | 100 | 100 | — |
| | polymerization: | | | | | | | | | | | | | | |
| | 1400 | | | | | | | | | | | | | | |
| | degree of | — | — | — | 100 | — | — | — | — | — | — | — | — | — | — |
| | polymerization: | | | | | | | | | | | | | | |
| | 2500 | | | | | | | | | | | | | | |
| | degree of | — | — | — | — | 100 | — | — | — | — | — | — | — | — | — |
| | polymerization: | | | | | | | | | | | | | | |
| | 3000 | | | | | | | | | | | | | | |
| plasticizer | DNP | 35 | 60 | 40 | 40 | 40 | 34 | 61 | — | — | — | — | — | — | 40 |
| | DDP | — | — | — | — | — | — | — | 35 | 60 | — | — | — | — | — |
| | DNOP | — | — | — | — | — | — | — | — | — | 35 | 60 | — | — | — |
| | DINP | — | — | — | — | — | — | — | — | — | — | — | 35 | 60 | — |

| | | | | | | | | | | | | | | |
|---|---|---|---|---|---|---|---|---|---|---|---|---|---|---|
| abrasion resistance | good | good | good | good | good | good | poor | good | good | good | poor | good | poor | poor |
| low-temperature flexibility | good | good | good | good | good | poor | good | poor | poor | good | good | poor | poor | good |
| heat resistance | good | good | good | good | good | good | good | good | good | poor | poor | poor | poor | poor |
| electrical wire workability | good | good | good | good | poor | good | good | good | good | good | good | good | good | good |

### [Evaluation]

The test samples of Examples and Comparative Examples were evaluated by the following methods for abrasion resistance, low-temperature flexibility, heat resistance, and electrical wire workability. Table 1 also shows the result.

<Abrasion Resistance>

The test samples obtained in Examples and Comparative Examples were subjected to an abrasion test according to the scrape abrasion standard of JASO D618. Note that the conditions of the scrape abrasion test were as follows.
Abrader: needle having a diameter of 0.45 ±0.01 mm
Load to a test sample: 7 ±0.05 N
The type of the needle: spring wire (glossy) material
Frequency: 55 ±5 cycles/minute (one cycle=one reciprocation)
Movement of the needle: 20 ±1 mm
Abrasion length: 15.5 ±1 mm
Test temperature: 23 ±1° C.

In addition, the test samples were evaluated as “good” if no electricity flowed between the metal conductor and the needle even when the number of reciprocations was 100 or more, The test samples were evaluated as “poor” if electricity flowed when the number of reciprocations was less than 100.

<Low-Temperature Flexibility>

First, the electrical wire test samples obtained in Examples and Comparative Examples were each cooled in air in an environment of −65° C. for 4 hours or more. Next, after the cooling, the electrical wire test sample was spirally wound around a metal mandrel having the same diameter (1.3 mm) as that of the electrical wire test sample. In this event, the electrical wire test samples thus wound were visually observed, and evaluated as “good” if the metal conductor was not exposed, or evaluated as “poor” if the metal conductor was exposed.

<Heat Resistance>

First, the electrical wire test samples obtained in Examples and Comparative Examples were each heated in a Geer oven in an environment of 85° C. while the air was replaced 8 times/hour for 3000 hours. Next, the heated electrical wire test sample was cooled in air at room temperature (23 ±5° C.) for 16 hours or more. Then, after the cooling, the electrical wire test sample was spirally wound around a metal mandrel having a diameter (1.95 mm) 1.5 times as large as that of the electrical wire test sample. In this event, the electrical wire test samples thus wound were visually observed, and evaluated as “good” if the metal conductor was not exposed, or evaluated as “poor” if the metal conductor was exposed.

<Electrical Wire Workability>

First, as metal conductors, core wires made of pure copper having a cross-sectional area of 0.3 mm²were prepared. Then, using a cover extruder having a screw diameter of 40 mm for producing electrical wire, the metal conductors were each covered with one of the resin compositions of Examples and Comparative Examples shown in Table 1. Note that, in the extrusion-molding, to make the cover layer have a thickness of 0.30 mm after the covering, the molding was performed by setting the extruder temperature at 180° C. and the wire speed at 300 m/minute. The surface of the test sample thus obtained was visually observed, and evaluated as “good” if the insulator surface was not rough, or evaluated as “poor” if the insulator surface was rough.

As shown in Table 1, it was revealed that Examples 1 to 5 according to the present embodiment each containing the vinyl chloride resin and dinonyl phthalate were excellent in abrasion resistance, low-temperature flexibility, and heat resistance. Moreover, it was revealed that Examples 1 to 4 according to the present embodiment were excellent also in electrical wire workability because the vinyl chloride resins had degrees of polymerization of 1000 to 2500.

While the present invention has been described above by way of Examples and Comparative Examples, the present invention is not limited thereto. Various modifications are possible within the gist of the present invention.

What is claimed is:

1. A resin composition comprising a vinyl chloride resin and a dinonyl phthalate, wherein
when a scrape abrasion test specified in JASO D618 is conducted on an insulated electrical wire comprising a conductor having a cross-sectional area of 0.3 mm² covered with the resin composition in a thickness of 0.30 mm, the number of reciprocations is 100 or more,
when the insulated electrical wire is wound around a mandrel having the same diameter as that of the insulated electrical wire in an environment of −65° C., the conductor is not exposed, and
when the insulated electrical wire having been heated at 85° C. for 3000 hours is wound around a mandrel having a diameter 1.5 times as large as that of the insulated electrical wire in an environment of 23 ±5° C., the conductor is not exposed.

2. The resin, composition according to claim 1, wherein a content of the dinonyl phthalate is 35 to 60 parts by mass relative to 100 parts by mass of the vinyl chloride resin.

3. The resin composition according to claim 1, wherein the vinyl chloride resin has a degree of polymerization of 1000 to 2500.

4. An insulated electrical wire comprising:
a cover layer made of the resin composition according to claim 1; and
a conductor covered with the cover layer.
